(19) United States
(12) Patent Application Publication
(10) Pub. No.: US 2026/0104987 A1
(43) Pub. Date: Apr. 16, 2026

(54) SYSTEMS, APPARATUSES, METHODS, AND COMPUTER PROGRAM PRODUCTS FOR INITIATING PERFORMANCE OF ONE OR MORE ASSET IMPLEMENTATION ACTIONS

(71) Applicant: Honeywell International Inc., Charlotte, NC (US)

(72) Inventors: Rajesh Kulandaivel Sankarapandian, Cumming, GA (US); Justin Thomas, Albuquerque, NM (US); Aaron Dsouza, Alpharetta, GA (US); Abhin Pai, Atlanta, GA (US)

(21) Appl. No.: 18/913,412

(22) Filed: Oct. 11, 2024

(51) Int. Cl. G06F 11/36; G06F 8/41

(52) U.S. Cl. CPC G06F 11/3684; G06F 8/42; G06F 11/3688

(57) ABSTRACT

Systems, apparatuses, methods, and computer program products are provided herein. For example, a method may include receiving a natural language input. In some embodiments, the method includes identifying an implementation domain of a plurality of implementation domains. In some embodiments, the method includes generating an operational program by applying the natural language input to a generative operational program model. In some embodiments, the method includes configuring the operational program by mapping the one or more asset feature inputs to one or more first asset feature templates and the one or more asset feature outputs to one or more second asset feature templates. In some embodiments, the method includes initiating performance of one or more asset implementation actions based at least in part on the operational program.

### TECHNOLOGICAL FIELD

Embodiments of the present disclosure relate generally to systems, apparatuses, methods, and computer program products for initiating performance of one or more asset implementation actions.

### BACKGROUND

Applicant has identified many technical challenges and difficulties associated with systems, apparatuses, methods, and computer program products for controlling, monitoring, and optimizing assets. Through applied effort, ingenuity, and innovation, Applicant has solved problems related to systems, apparatuses, methods, and computer program products for controlling, monitoring, and optimizing assets by developing solutions embodied in the present disclosure, which are described in detail below.

### BRIEF SUMMARY

Various embodiments described herein relate to systems, apparatuses, methods, and computer program products for initiating performance of one or more asset implementation actions.

In accordance with one aspect of the disclosure, a method is provided. In some embodiments, the method includes receiving a natural language input. In some embodiments, the method includes identifying an implementation domain of a plurality of implementation domains. In some embodiments, the implementation domain is associated with the natural language input. In some embodiments, the implementation domain is associated with a domain language of a plurality of domain languages. In some embodiments, the method includes generating an operational program by applying the natural language input to a generative operational program model. In some embodiments, a first portion of the operational program is structured in accordance with the domain language. In some embodiments, the operational program is configured to determine one or more asset feature outputs using one or more asset feature inputs. In some embodiments, the method includes configuring the operational program by mapping the one or more asset feature inputs to one or more first asset feature templates and the one or more asset feature outputs to one or more second asset feature templates. In some embodiments, the method includes initiating performance of one or more asset implementation actions based at least in part on the operational program.

In some embodiments, the implementation domain is one of an aerospace implementation domain, a structures implementation domain, an industrial implementation domain, a science implementation domain, a cybersecurity implementation domain, or an operations implementation domain.

In some embodiments, the implementation domain corresponds to an asset.

In some embodiments, the method includes training the generative operational program model using one or more historical operational programs and one or more historical natural language inputs.

In some embodiments, the method includes generating an operational program aspect set by applying the natural language input to the generative operational program model.

In some embodiments, a second portion of the operational program is structured in accordance with a natural language format.

In some embodiments, the method includes performing a syntax operation on the operational program.

In some embodiments, the method includes generating an operational program testing routine.

In some embodiments, the operational program testing routine comprises one or more testing asset feature inputs and one or more testing asset feature outputs.

In some embodiments, the method includes applying the operational program testing routine to the operational program.

In some embodiments, initiating performance of the one or more asset implementation actions includes generating one or more operational program implementation interface components.

In some embodiments, initiating performance of the one or more asset implementation actions includes causing at least one of the one or more operational program implementation interface components to be rendered to an operational program interface.

In some embodiments, the one or more operational program implementation interface components comprise one or more of an operational program generation interface component, an operational program configuration interface component, an operational program testing routine interface component, or an operational program output interface component.

In some embodiments, initiating performance of the one or more asset implementation actions includes detecting at least one fault associated with an asset.

In some embodiments, initiating performance of the one or more asset implementation actions includes transmitting at least one operational action instruction to a remote computing device.

In some embodiments, initiating performance of the one or more asset implementation actions includes generating a first asset feature output of the one or more asset feature outputs.

In some embodiments, initiating performance of the one or more asset implementation actions includes causing actuation of one or more components of an asset.

In accordance with another aspect of the disclosure, an apparatus is provided. In some embodiments, the apparatus includes memory and one or more processors communicatively coupled to the memory. In some embodiments, the one or more processors are configured to receive a natural language input. In some embodiments, the one or more processors are configured to identify an implementation domain of a plurality of implementation domains. In some embodiments, the implementation domain is associated with the natural language input. In some embodiments, the implementation domain is associated with a domain language of a plurality of domain languages. In some embodiments, the one or more processors are configured to generate an operational program by applying the natural language input to a generative operational program model. In some embodiments, a first portion of the operational program is structured in accordance with the domain language. In some embodiments, the operational program is configured to determine one or more asset feature outputs using one or more asset feature inputs. In some embodiments, the one or more processors are configured to configure the operational program by mapping the one or more asset feature inputs to one or more first asset feature templates and the one or more asset feature outputs to one or more second asset feature templates. In some embodiments, the one or more processors are configured to initiate performance of one or more asset implementation actions based at least in part on the operational program.

In some embodiments, the implementation domain is one of an aerospace implementation domain, a structures implementation domain, an industrial implementation. domain, a science implementation domain, a cybersecurity implementation domain, or an operations implementation domain.

In some embodiments, a second portion of the operational program is structured in accordance with a natural language format.

In some embodiments, the one or more processors are configured to performing a syntax operation on the operational program.

In some embodiments, the one or more processors are configured to generating an operational program testing routine.

In some embodiments, the operational program testing routine comprises one or more testing asset feature inputs and one or more testing asset feature outputs.

In some embodiments, the one or more processors are configured to applying the operational program testing routine to the operational program.

In accordance with another aspect of the disclosure, a computer program product is provided. In some embodiments, the computer program product includes at least one non-transitory computer-readable storage medium having computer program code stored thereon. In some embodiments, the computer program code, in execution with at least one processor, configures the computer program product for receiving a natural language input. In some embodiments, the computer program code, in execution with at least one processor, configures the computer program product for identifying an implementation domain of a plurality of implementation domains. In some embodiments, the implementation domain is associated with the natural language input. In some embodiments, the implementation domain is associated with a domain language of a plurality of domain languages. In some embodiments, the computer program code, in execution with at least one processor, configures the computer program product for generating an operational program by applying the natural language input to a generative operational program model. In some embodiments, a first portion of the operational program is structured in accordance with the domain language. In some embodiments, the operational program is configured to determine one or more asset feature outputs using one or more asset feature inputs. In some embodiments, the computer program code, in execution with at least one processor, configures the computer program product for configuring the operational program by mapping the one or more asset feature inputs to one or more first asset feature templates and the one or more asset feature outputs to one or more second asset feature templates. In some embodiments, the computer program code, in execution with at least one processor, configures the computer program product for initiating performance of one or more asset implementation actions based at least in part on the operational program.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an exemplary block diagram of an environment in which embodiments of the present disclosure may operate;

FIG. 2 illustrates an exemplary block diagram of an example apparatus that may be specially configured in accordance with an example embodiment of the present disclosure;

FIG. 3 illustrates an example interface component in accordance with one or more embodiments of the present disclosure;

FIG. 4 illustrates an example interface component in accordance with one or more embodiments of the present disclosure;

FIG. 5 illustrates an example interface component in accordance with one or more embodiments of the present disclosure;

FIG. 6 illustrates an example interface component in accordance with one or more embodiments of the present disclosure;

FIG. 7 illustrates a flowchart of an example method in accordance with one or more embodiments of the present disclosure;

FIG. 8 illustrates a flowchart of an example method in accordance with one or more embodiments of the present disclosure; and

FIG. 9 illustrates a flowchart of an example method in accordance with one or more embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration. ” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The use of the term “circuitry” as used herein with respect to components of a system, or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communication circuitry, input/output circuitry, and the like. In some embodiments, other elements may provide or supplement the functionality of particular circuitry. Alternatively, or additionally, in some embodiments, other elements of a system and/or apparatus described herein may provide or supplement the functionality of another particular set of circuitry. For example, a processor may provide processing functionality to any of the sets of circuitry, a memory may provide storage functionality to any of the sets of circuitry, communications circuitry may provide network interface functionality to any of the sets of circuitry, and/or the like.

### Overview

Example embodiments disclosed herein address technical problems associated with systems, apparatuses, methods, and computer program products for controlling, monitoring, and optimizing assets. As would be understood by one skilled in the field to which this disclosure pertains, there are numerous example scenarios in which systems, apparatuses, methods, and computer program products for controlling, monitoring, and optimizing assets are desirable.

In many applications, it may be desirable to use systems, apparatuses, methods, and computer program products for controlling, monitoring, and optimizing assets. In some implementations, it may be desirable to use systems, apparatuses, methods, and computer program products for controlling, monitoring, and optimizing assets to impact the operations of an asset. For example, it may be desirable to use systems, apparatuses, methods, and computer program products for controlling, monitoring, and optimizing assets to impact the operations of an asset when the asset includes a processing plant, a structure, an aircraft, and/or the like. In some implementations, it may be desirable to use systems, apparatuses, methods, and computer program products for controlling, monitoring, and optimizing assets to detect faults associated with an asset. For example, it may be desirable to use systems, apparatuses, methods, and computer program products for controlling, monitoring, and optimizing assets to detect faults associated with an asset when the asset includes a processing plant, a structure, an aircraft, and/or the like.

Example solutions for controlling, monitoring, and optimizing assets include using computing devices and databases to impact the operations of an asset and/or detect faults associated with an apparatus. However, such example solutions are inefficient, reactive, simplistic, and technically deficient. For example, such example solutions are inefficient because such example solutions do not use a generative operational program model that is specifically configured for a particular implementation domain to impact operations of an asset and/or detect faults associated with an asset. As a result, such example solutions cause computing devices and databases to suffer from high latency, consume excessive processing power, and consume excessive memory. As another example, such example solutions are reactive because such example solutions are unable to automatically implement asset implementation actions that include automatically causing transmission of operational action instructions and/or actuation of components of an asset. As another example, such example solutions are simplistic because such example solutions are unable to use a natural language input to generate an operational program that is associated with a particular domain language that is in a machine-readable format. As another example, such example solutions are technically deficient because such example solutions do not automatically implement operational program testing routines and/or syntax operations. Accordingly, there is a need for systems, apparatuses, methods, and computer program products that are able to control, monitor, and/or optimize assets in an efficient, a proactive, a sophisticated, and a technically sufficient manner.

Thus, to address these and/or other issues related to such example solutions, example systems, apparatuses, methods, and computer program products for initiating performance of one or more asset implementation actions are disclosed herein. For example, an embodiment in this disclosure, described in greater detail below, includes a method that includes receiving a natural language input. In some embodiments, the method includes identifying an implementation domain of a plurality of implementation domains. In some embodiments, the implementation domain is associated with the natural language input. In some embodiments, the implementation domain is associated with a domain language of a plurality of domain languages. In some embodiments, the method includes generating an operational program by applying the natural language input to a generative operational program model. In some embodiments, a first portion of the operational program is structured in accordance with the domain language. In some embodiments, the operational program is configured to determine one or more asset feature outputs using one or more asset feature inputs. In some embodiments, the method includes configuring the operational program by mapping the one or more asset feature inputs to one or more first asset feature templates and the one or more asset feature outputs to one or more second asset feature templates. In some embodiments, the method includes initiating performance of one or more asset implementation actions based at least in part on the operational program. Accordingly, the systems, apparatuses, methods, and computer program products provided herein are able to initiate performance of one or more asset implementation actions in an efficient, a proactive, a sophisticated, and a technically sufficient manner.

### Example Systems and Apparatuses

Embodiments of the present disclosure herein include systems, apparatuses, methods, and computer program products for initiating performance of one or more asset implementation actions. It should be readily appreciated that the embodiments of the apparatus, systems, methods, and computer program product described herein may be configured in various additional and alternative manners in addition to those expressly described herein.

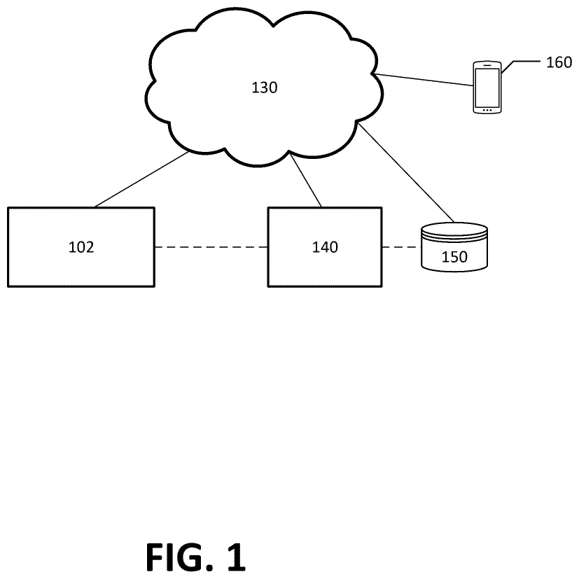

FIG. 1 illustrates an exemplary block diagram of an environment 100 in which embodiments of the present disclosure may operate. Specifically, FIG. 1 illustrates an asset 102.

In some embodiments, the asset 102 is associated with one or more of a plurality of implementation domains. In some embodiments, the plurality of implementation domains includes an aerospace implementation domain. In this regard, when the asset 102 is associated with an aerospace implementation domain the asset 102 may be any machine, robot, computing devices, and/or apparatus comprised of hardware, software, firmware, and/or any combination thereof, that maneuvers throughout an environment through a medium, such as air. For example, the asset 102 may include airplanes, helicopters, drones, and/or the like. Additionally, or alternatively, when the asset 102 is associated with an aerospace implementation domain, the asset 102 may be any other computing device or system associated with an aircraft, such as an aircraft control system, aircraft maintenance system, and/or the like.

In some embodiments, the plurality of implementation domains includes a structures implementation domain. In this regard, when the asset 102 is associated with a structures implementation domain, the asset 102 may be an industrial building, office building, building associated with a plant, and/or the like. In some embodiments, the plurality of implementation domains includes an industrial implementation domain. In this regard, when the asset 102 is associated with a structures implementation domain, the asset 102 may be a processing plant that receives and processes ingredients as inputs to create a processed product, such as a hydrocarbon processing plant, a refinery, a pulp and paper plant, a chemical plant, an alumina plant, a drilling facility, a fracking field, and/or the like.

In some embodiments, the plurality of implementation domains includes a science implementation domain. In this regard, when the asset 102 is associated with a science implementation domain, the asset 102 may be any system, computing device, testing apparatus, and/or the like that is configured to facilitate scientific operations, such as life science operations (e.g., a computing device for facilitating testing of life science products). In some embodiments, the plurality of implementation domains includes a cybersecurity implementation domain. In this regard, when the asset 102 is associated with a cybersecurity implementation domain, the asset 102 may be any system, computing device, and/or apparatus that is configured to perform cybersecurity operations. In some embodiments, the plurality of implementation domains includes an operations implementation domain. In this regard, when the asset 102 is associated with an operations implementation domain, the asset 102 may be any system, computing device, and/or apparatus configured to facilitate operations, such as supply chain operations.

In some embodiments, the asset 102 includes any number of individual components. The components of the asset 102 may perform a particular function during operation of the asset 102. For example, the individual components of the asset 102 may include a pump, such as when the asset 102 is associated with an industrial implementation domain.

In some embodiments, each individual component of the asset 102 is associated with a determinable location. The determinable location of a particular component in some embodiments represents an absolute position (e.g., GPS coordinates, latitude, and longitude locations, and/or the like) or a relative position (e.g., a point representation of the location of a component from a local origin point corresponding to the asset 102). In some embodiments, a component includes or otherwise is associated with a location sensor and/or software-driven location services that provide the location data representing the location corresponding to that component. In other embodiments the location of a component is stored and/or otherwise predetermined within a software environment, provided by a user and/or otherwise determinable to one or more systems.

Additionally, or alternatively, in some embodiments, the asset 102 itself is associated with a determinable location. The determinable location of the asset 102 in some embodiments represents an absolute position (e.g., GPS coordinates, latitude and longitude locations, an address, and/or the like) or a relative position of the asset 102 (e.g., an identifier representing the location of the asset 102 as compared to one or more other plants, one or more other buildings, an enterprise headquarters, or general description in the world for example based at least in part on continent, state, or other definable region). In some embodiments, the asset 102 includes or otherwise is associated with a location sensor and/or software-driven location services that provide the location data corresponding to the asset 102. In other embodiments, the location of the asset 102 is stored and/or otherwise determinable to one or more systems.

The network 130 may be embodied in any of a myriad of network configurations. In some embodiments, the network 130 may be a public network (e.g., the Internet). In some embodiments, the network 130 may be a private network (e.g., an internal localized, or closed-off network between particular devices). In some other embodiments, the network 130 may be a hybrid network (e.g., a network enabling internal communications between particular connected devices and external communications with other devices). In various embodiments, the network 130 may include one or more base station(s), relay(s), router(s), switch(es), cell tower(s), communications cable(s), routing station(s), and/or the like. In various embodiments, components of the environment 100 may be communicatively coupled to transmit data to and/or receive data from one another over the network 130. Such configuration(s) include, without limitation, a wired or wireless Personal Area Network (PAN), Local Area Network (LAN), Metropolitan Area Network (MAN), Wide Area Network (WAN), and/or the like.

In some embodiments, the environment 100 may include a generative operational program system 140. In some embodiments, for example, the generative operational program system 140 may be configured to initiate performance of one or more asset implementation actions. The generative operational program system 140 may be electronically and/or communicatively coupled to the asset 102, individual components of the asset 102, one or more databases 150, and/or one or more user devices 160. The generative operational program system 140 may be located remotely, in proximity of, and/or within the asset 102. In some embodiments, the generative operational program system 140 is configured via hardware, software, firmware, and/or a combination thereof, to perform data intake of one or more types of data associated with one or more of the asset 102. Additionally, or alternatively, in some embodiments, the generative operational program system 140 is configured via hardware, software, firmware, and/or a combination thereof, to generate and/or transmit command(s) that control, adjust, or otherwise impact operations of one or more of the asset 102 or specific component(s) thereof, for example for controlling one or more operations of the asset 102. Additionally or alternatively still, in some embodiments, the generative operational program system 140 is configured via hardware, software, firmware, and/or a combination thereof, to perform data reporting and/or other data output process(es) associated with monitoring or otherwise analyzing operations of one or more of the asset 102 or specific component(s) thereof, for example for generating and/or outputting report(s) corresponding to the operations performed via the asset 102. For example, in various embodiments, the generative operational program system 140 may be configured to execute and/or perform one or more operations and/or functions described herein.

The one or more databases 150 may be configured to receive, store, and/or transmit data. In some embodiments, the one or more databases 150 may be associated with data associated with the asset 102. In some embodiments, the data may be received from the asset 102. In this regard, for example, the asset 102 may have one or more sensors that capture data associated with the asset 102. In some embodiments, the data may be received from the generative operational program system 140. In this regard, for example, the generative operational program system 140 may be configured to identify data associated with the asset 102. In some embodiments, the one or more databases 150 may be associated with data received from the asset 102 and/or the generative operational program system 140 in real-time. Additionally, or alternatively, the one or more databases 150 may be associated with data received from the asset 102 and/or the generative operational program system 140 on a periodic basis (e.g., the data may be received from the asset 102 and/or the generative operational program system 140 once per day). Additionally, or alternatively, the one or more databases 150 may be associated with historical data received from the asset 102 and/or the generative operational program system 140. Additionally, or alternatively, the one or more databases 150 may be associated with data received from the asset 102 and/or the generative operational program system 140 in response to a request for the data. Additionally, or alternatively, the one or more databases 150 may be associated with data inputted (e.g., by a user) into the generative operational program system 140 and/or the one or more user devices 160.

The one or more user devices 160 may be associated with users of the generative operational program system 140. In various embodiments, the generative operational program system 140 may generate and/or transmit a message, alert, or indication to a user via a user device 160. Additionally, or alternatively, a user device 160 may be utilized by a user to remotely access the generative operational program system 140. This may be by, for example, an application operating on the user device 160. A user may access the generative operational program system 140 remotely, including one or more visualizations, reports, and/or real-time displays.

Additionally, while FIG. 1 illustrates certain components as separate, standalone entities communicating over the network 130, various embodiments are not limited to this configuration. In other embodiments, one or more components may be directly connected and/or share hardware or the like. For example, in some embodiments, the generative operational program system 140 may include the one or more databases 150, which may collectively be located in or at the asset 102.

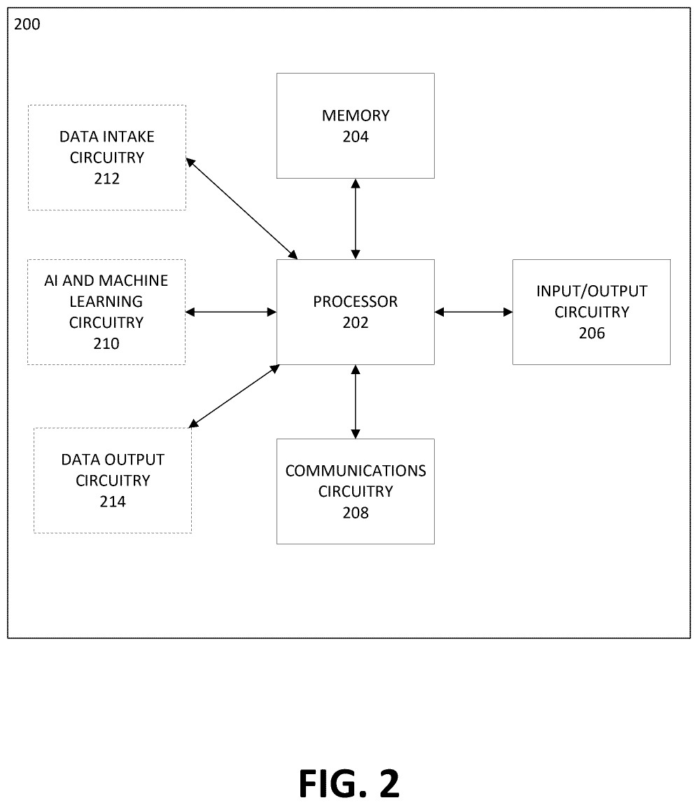

FIG. 2 illustrates an exemplary block diagram of an example apparatus that may be specially configured in accordance with an example embodiment of the present disclosure. Specifically, FIG. 2 depicts an example computing apparatus 200 (“apparatus 200”) specially configured in accordance with at least some example embodiments of the present disclosure. For example, the computing apparatus 200 may be embodied as one or more of a specifically configured personal computing apparatus, a specifically configured cloud-based computing apparatus, a specifically configured embedded computing device (e.g., configured for edge computing, and/or the like). Examples of an apparatus 200 may include, but is not limited to, a generative operational program system 140, the one or more databases 150, and/or a user device 160. The apparatus 200 includes processor 202, memory 204, input/output circuitry 206, communications circuitry 208, and/or optional artificial intelligence (“AI”) and machine learning circuitry 210. In some embodiments, the apparatus 200 is configured to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

In various embodiments, such as computing apparatus 200 of a generative operational program system 140 or of a user device 160 may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein. In this regard, the apparatus 200 embodies a particular, specially configured computing entity transformed to enable the specific operations described herein and provide the specific advantages associated therewith, as described herein.

Processor 202 or processor circuity 202 may be embodied in a number of different ways. In various embodiments, the use of the terms “processor” should be understood to include a single core processor, a multi-core processor, multiple processors internal to the apparatus 200, and/or one or more remote or “cloud” processor(s) external to the apparatus 200. In some example embodiments, processor 202 may include one or more processing devices configured to perform independently. Alternatively, or additionally, processor 202 may include one or more processor(s) configured in tandem via a bus to enable independent execution of operations, instructions, pipelining, and/or multithreading.

In an example embodiment, the processor 202 may be configured to execute instructions stored in the memory 204 or otherwise accessible to the processor. Alternatively, or additionally, the processor 202 may be configured to execute hard-coded functionality. As such, whether configured by hardware or software methods, or by a combination thereof, processor 202 may represent an entity (e.g., physically embodied in circuitry) capable of performing operations according to embodiments of the present disclosure while configured accordingly. Alternatively, or additionally, processor 202 may be embodied as an executor of software instructions, and the instructions may specifically configure the processor 202 to perform the various algorithms embodied in one or more operations described herein when such instructions are executed. In some embodiments, the processor 202 includes hardware, software, firmware, and/or a combination thereof that performs one or more operations described herein.

In some embodiments, the processor 202 (and/or co-processor or any other processing circuitry assisting or otherwise associated with the processor) is/are in communication with the memory 204 via a bus for passing information among components of the apparatus 200.

Memory 204 or memory circuitry 204 may be non-transitory and may include, for example, one or more volatile and/or non-volatile memories. In some embodiments, the memory 204 includes or embodies an electronic storage device (e.g., a computer readable storage medium). In some embodiments, the memory 204 is configured to store information, data, content, applications, instructions, or the like, for enabling an apparatus 200 to carry out various operations and/or functions in accordance with example embodiments of the present disclosure.

Input/output circuitry 206 may be included in the apparatus 200. In some embodiments, input/output circuitry 206 may provide output to the user and/or receive input from a user. The input/output circuitry 206 may be in communication with the processor 202 to provide such functionality. The input/output circuitry 206 may comprise one or more user interface(s). In some embodiments, a user interface may include a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more operations and/or functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a computing device and/or other display associated with a user.

Communications circuitry 208 may be included in the apparatus 200. The communications circuitry 208 may include any means such as a device or circuitry embodied in either hardware or a combination of hardware and software that is configured to receive and/or transmit data from/to a network and/or any other device, circuitry, or module in communication with the apparatus 200. In some embodiments the communications circuitry 208 includes, for example, a network interface for enabling communications with a wired or wireless communications network. Additionally, or alternatively, the communications circuitry 208 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 208 may include circuitry for interacting with an antenna(s) and/or other hardware or software to cause transmission of signals via the antenna(s) and/or to handle receipt of signals received via the antenna(s). In some embodiments, the communications circuitry 208 enables transmission to and/or receipt of data from a user device, one or more sensors, and/or other external computing device(s) in communication with the apparatus 200.

Data intake circuitry 212 may be included in the apparatus 200. The data intake circuitry 212 may include hardware, software, firmware, and/or a combination thereof, designed and/or configured to capture, receive, request, and/or otherwise gather data associated with operations of the asset 102. In some embodiments, the data intake circuitry 212 includes hardware, software, firmware, and/or a combination thereof, that communicates with one or more sensor(s) component(s), and/or the like within the asset 102 to receive particular data associated with such operations of the asset 102. Additionally, or alternatively, in some embodiments, the data intake circuitry 212 includes hardware, software, firmware, and/or a combination thereof, that retrieves particular data associated with the asset 102 from one or more data repository/repositories accessible to the apparatus 200.

AI and machine learning circuitry 210 may be included in the apparatus 200. The AI and machine learning circuitry 210 may include hardware, software, firmware, and/or a combination thereof designed and/or configured to request, receive, process, generate, and transmit data, data structures, control signals, and electronic information for training and executing a trained AI and machine learning model configured for facilitating the operations and/or functionalities described herein. For example, in some embodiments the AI and machine learning circuitry 210 includes hardware, software, firmware, and/or a combination thereof, that identifies training data and/or utilizes such training data for training a particular machine learning model, AI, and/or other model to generate particular output data based at least in part on learnings from the training data. Additionally, or alternatively, in some embodiments, the AI and machine learning circuitry 210 includes hardware, software, firmware, and/or a combination thereof, that embodies or retrieves a trained machine learning model, AI and/or other specially configured model utilized to process inputted data. Additionally, or alternatively, in some embodiments, the AI and machine learning circuitry 210 includes hardware, software, firmware, and/or a combination thereof that processes received data utilizing one or more algorithm(s), function(s), subroutine(s), and/or the like, in one or more pre-processing and/or subsequent operations that need not utilize a machine learning or AI model.

Data output circuitry 214 may be included in the apparatus 200. The data output circuitry 214 may include hardware, software, firmware, and/or a combination thereof, that configures and/or generates an output based at least in part on data processed by the apparatus 200. In some embodiments, the data output circuitry 214 includes hardware, software, firmware, and/or a combination thereof, that generates a particular report based at least in part on the processed data, for example where the report is generated based at least in part on a particular reporting protocol. Additionally, or alternatively, in some embodiments, the data output circuitry 214 includes hardware, software, firmware, and/or a combination thereof, that configures a particular output data object, output data file, and/or user interface for storing, transmitting, and/or displaying. For example, in some embodiments, the data output circuitry 214 generates and/or specially configures a particular data output for transmission to another system sub-system for further processing. Additionally, or alternatively, in some embodiments, the data output circuitry 214 includes hardware, software, firmware, and/or a combination thereof, that causes rendering of a specially configured user interface based at least in part on data received by and/or processing by the apparatus 200.

In some embodiments, two or more of the sets of circuitries 202-214 are combinable. Alternatively, or additionally, one or more of the sets of circuitry 202-214 perform some or all of the operations and/or functionality described herein as being associated with another circuitry. In some embodiments, two or more of the sets of circuitry 202-214 are combined into a single module embodied in hardware, software, firmware, and/or a combination thereof. For example, in some embodiments, one or more of the sets of circuitry, for example the AI and machine learning circuitry 210, may be combined with the processor 202, such that the processor 202 performs one or more of the operations described herein with respect to the AI and machine learning circuitry 210.

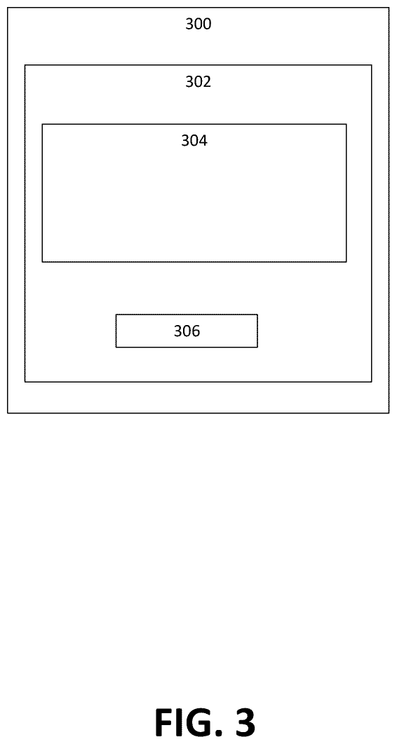

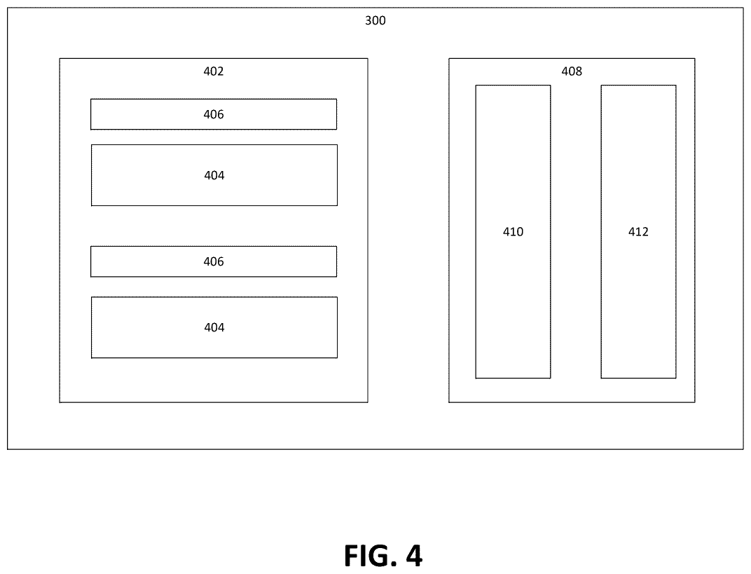

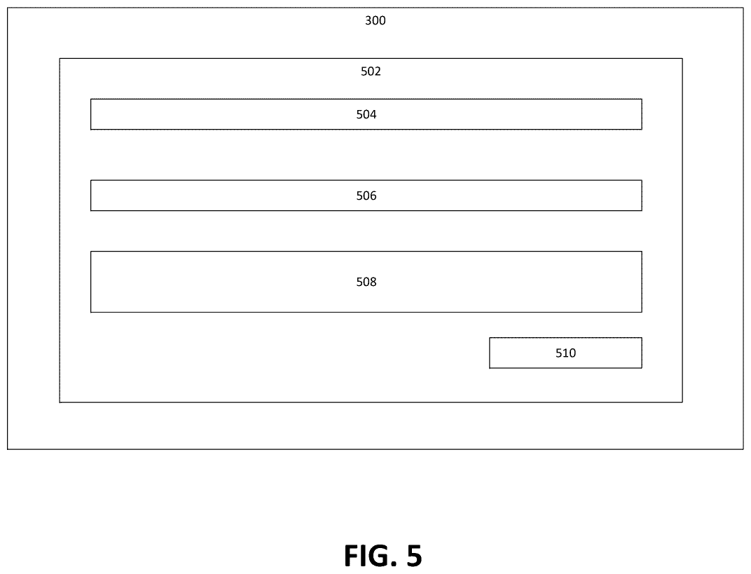

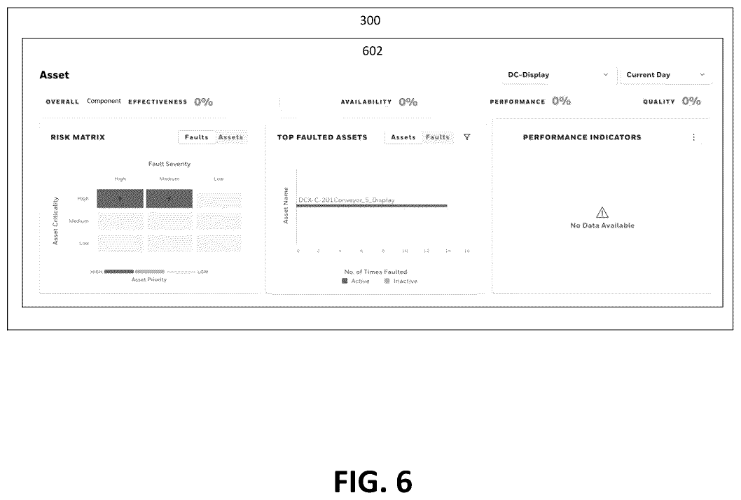

With reference to FIGS. 1-6, in some embodiments, the generative operational program system 140 is configured to receive a natural language input. In some embodiments, a natural language input includes words, phrases, sentences paragraphs, messages, prompts, and/or the like. In some embodiments, a natural language input includes words, phrases, sentences, paragraphs, messages, prompts, and/or the like that represent instructions for generating an operational program. For example, a natural language input may include words, phrases, sentences, paragraphs, messages, prompts, and/or the like that represent instructions for generating an operational program associated with a voltage imbalance of an electric motor, such as an electric motor associated with the asset 102. As another example, a natural language input may include words, phrases, sentences, paragraphs, messages, prompts, and/or the like that represent instructions for determining a pump utilization, such as a pump associated with the asset 102.

In some embodiments, the generative operational program system 140 is configured to receive a natural language input via a natural language input interface component 302. In this regard, in some embodiments, the generative operational program system 140 is configured to generate the natural language input interface component 302. In some embodiments, the natural language input interface component 302 includes a natural language interface element 304. In some embodiments, the natural language interface element 304 is configured to be used by a user to input a natural language input via the natural language interface element 304. In some embodiments, the natural language input interface component 302 includes an operational program generation interface element 306.

In some embodiments, the generative operational program system 140 is configured to cause the natural language input interface component 302 to be rendered to an operational program interface 300. In some embodiments, the operational program interface 300 is configured to be provided on the generative operational program system 140, the user device 160, a computing device associated with the asset 102, and/or one or more external systems (e.g., a remote computing device).

In some embodiments, the generative operational program system 140 is configured to identify an implementation domain of the plurality of implementation domains. In some embodiments, the generative operational program system 140 is configured to identify an implementation domain associated with the natural language input. In this regard, in some embodiments, the generative operational program system 140 is configured to identify the implementation domain of the plurality of implementation domains associated with the natural language input. For example, if the natural language input is associated with an industrial implementation domain, the generative operational program system 140 may be configured to identify the industrial implementation domain.

In some embodiments, identifying an implementation domain of the plurality of implementation domains includes the generative operational program system 140 being configured to receive an indication of an implementation domain. For example, the generative operational program system 140 may receive an indication of a particular implementation domain of the plurality of implementation domains via the natural language input interface component 302. Said differently, for example, the natural language input interface component 302 may be configured such that a user can input a natural language input and/or indicate an implementation domain using the natural language input interface component 302.

Additionally, or alternatively, identifying an implementation domain of the plurality of implementation domains includes the generative operational program system 140 being configured to determine the implementation using a natural language input. In this regard, in some embodiments, the generative operational program system 140 is configured to use the words, phrases, sentences, paragraphs, messages, prompts, and/or the like provided in a natural language input to determine an implementation domain (e.g., an implementation domain associated with the natural language input). For example, if a natural language input includes the word pump, the generative operational program system 140 may be configured to determine that the natural language input is associated with an industrial implementation domain of the plurality of implementation domains. As another example, if a natural language input includes a sentence that describes aircraft operations, the generative operational program system 140 may be configured to determine that the natural language input is associated with an aerospace implementation domain of the plurality of implementation domains.

In some embodiments, each of the plurality of implementation domains is associated with one or more of a plurality of domain languages. In some embodiments, a domain language is a programming language that is used to carry out computing operations in a particular implementation domain. For example, a domain language may include a python-based language, a domain specific language, and/or the like. In some embodiments, a domain language is in a machine-readable format (e.g., a format readable by machines and/or computing devices). In some embodiments, a domain language in a machine-readable format is not readable or understandable by a user (e.g., a human) associated with the generative operational program system 140.

In some embodiments, the generative operational program system 140 is configured to identify one or more asset feature inputs. In some embodiments, an asset feature input includes one or more items of data representative and/or indicative of one or more determined and/or captured features associated with the asset 102 that is an input to an operational program. For example, an asset feature input may be representative of a voltage associated with a motor in the asset 102. As another example, an asset feature input may be representative of a current associated with a motor in the asset 102. As another example, an asset feature input may be representative of a density associated with a component of the asset 102. As another example, an asset feature input may be representative of a design efficiency associated with a component of the asset 102. As another example, an asset feature input may be representative of an electrical power associated with the asset 102. As another example, an asset feature input may be representative of a flow rate associated with a pump in the asset 102. In some embodiments, identifying one or more asset feature inputs includes the generative operational program system 140 being configured to receive the one or more asset feature inputs, such as from the asset 102. Additionally, or alternatively, identifying one or more asset feature inputs includes the generative operational program system 140 being configured to determine one or more asset feature inputs. For example, the generative operational program system 140 may be configured to determine one or more asset feature inputs using one or more previously received asset feature inputs.

In some embodiments, the generative operational program system 140 is configured to identify and/or determine one or more asset feature outputs. In some embodiments, an asset feature output includes one or more items of data representative and/or indicative of one or more determined features associated with the asset 102 that is an output of an operational program. For example, an asset feature output may be representative of a voltage imbalance associated with a motor in the asset 102. As another example, an asset feature output may be representative of a utilization associated with a pump in the asset 102. As another example, an asset feature output may be representative of a breakeven point associated with the asset 102. As another example, an asset feature output may be representative of a degradation loss associated with a component in the asset 102.

In some embodiments, the generative operational program system 140 is configured to generate an operational program. In some embodiments, an operational program includes a first portion. In some embodiments, the first portion of an operational program includes one or more computing programs, computing formulas, and/or computing operations that that represent a relationship between one or more asset feature inputs and one or more asset feature outputs. In this regard, in some embodiments, the first portion of an operational program may include computing programs, computing formulas, and/or computing operations that are implemented to determine one or more feature outputs using one or more feature inputs. For example, the first portion of an operational program may include computing programs, computing formulas, and/or computing operations that are implemented to determine a voltage imbalance (e.g., an asset feature output) using a motor current (e.g., an asset feature input).

In some embodiments, the first portion of an operational program is structured in accordance with a domain language of the plurality of languages. In this regard, in some embodiments, the first portion of an operational program is structured in a machine-readable format. In some embodiments, the first portion of an operational program is structured in accordance with a domain language that corresponds to an implementation domain associated with the asset 102 and/or an implementation domain identified by the generative operational program system 140. For example, the first portion of an operational program may be structured in accordance with a python-based language when an implementation domain associated with the asset 102 uses the python-based language.

In some embodiments, an operational program includes a second portion. In some embodiments, the second portion of an operational program includes one or more configuration instructions. In some embodiments, a configuration instruction includes one or more items of data representative and/or indicative of an instruction or explanation related to one or more computing programs, computing formulas, and/or computing operations included in the first portion of an operational program. For example, a configuration instruction may include an instruction and/or explanation related to a particular computing operation included in the first portion of an operational program (e.g., that the purpose of a particular computing operation is to determine a current associated with a motor).

In some embodiments, the second portion of an operational program is structured in accordance with a natural language format. In this regard, in some embodiments, the second portion of an operational program includes one or more configuration instructions that are provided in words, phrases, sentences paragraphs, messages, prompts, and/or the like.

In some embodiments, the generative operational program system 140 is configured to generate an operational program aspect set. For example, the generative operational program system 140 may be configured to generate an operational program aspect set that is associated with a generated operational program. In some embodiments, an operational program aspect set is structured in accordance with a natural language format. Additionally, or alternatively, an operational program aspect set is structured in accordance with a machine-readable format, such as in a particular domain language.

In some embodiments, an operational program aspect set includes a program type associated with an operational program. In this regard, in some embodiments, a program type is representative of types of asset feature outputs that are determined using an operational program. For example, a program type may be representative of a voltage imbalance when an operational program is configured to determine one or more asset feature outputs that include a voltage imbalance.

In some embodiments, an operational program aspect set includes a program name associated with an operational program. In this regard, in some embodiments, a program name is representative of a name associated with an operational program. In some embodiments, a program name may be generated in accordance with a naming convention associated with the asset 102, an implementation domain associated with the asset 102, and/or a domain language associated with an implementation domain.

In some embodiments, an operational program aspect set includes a program description associated with an operational program. In some embodiments, a program description is representative of a description of one or more computing programs, computing formulas, and/or computing operations that are included in an operational program.

In some embodiments, the generative operational program system 140 is configured to generate an operational program and/or an operational program aspect set by applying a natural language input to a generative operational program model. In some embodiments, the generative operational program model is a data entity that describes parameters, hyper-parameters, and/or defined operations of a rules-based, machine learning model, and/or generative artificial intelligence model (e.g., model including at least one of one or more rule-based layers, one or more layers that depend on trained parameters, coefficients, and/or the like) configured to generate an operational program and/or an operational program aspect set. In this regard, in some embodiments, the generative operational program model may be configured to utilize one or more of any type of machine learning, rules-based, and/or artificial intelligence techniques including one or more of computer vision techniques, supervised learning (e.g., using user feedback), unsupervised learning, semi-supervised learning, reinforcement learning, computer vision techniques, sequence modeling techniques, language processing techniques, neural network techniques, generative artificial intelligence techniques, filtration techniques, grouping techniques, sorting techniques, trend techniques, correlation techniques, anomaly detection techniques, clustering techniques, and/or the like.

In some embodiments, the generative operational program system 140 is configured to train the generative operational program model. In some embodiments, the generative operational program system 140 is configured to train the generative operational program model using one or more historical operational programs and/or one or more historical natural language inputs. In this regard, in some embodiments, training the generative operational model includes the generative operational program system 140 being configured cause the generative operational program model to generate a training operational program using the one or more historical natural language inputs and then compare the training operational program against the one or more historical operational programs.

In some embodiments, the generative operational program system 140 is configured to generate an operational program in response to receiving a natural language input. For example, the generative operational program system 140 may be configured to generate an operational program upon receiving a natural language input. Additionally, or alternatively, the generative operational program system 140 is configured to generate an operational program in response to a selection of the operational program generation interface element 306.

In some embodiments, the generative operational program system 140 is configured to perform a syntax operation on an operational program. For example, the generative operational program system 140 may be configured to perform a syntax operation on the operational program after the operational program has been generated by the generative operational program system 140 using the generative operational program model. In some embodiments, a syntax operation includes a computing operation configured to determine whether the syntax of the first portion of an operational program was generated in accordance with a syntax protocol associated the domain language in which the first portion of the operational program is structured in accordance with. In some embodiments, if a syntax operation determines that the first portion of an operational program is not in accordance with an associated syntax protocol, the generative operational program system 140 may be configured to generate an alert. Additionally, or alternatively, a syntax operation includes a computing operation configured to determine whether the syntax of the second portion of an operational program was generated in accordance with a syntax protocol of a natural language format. In some embodiments, if a syntax operation determines that the second portion of an operational program is not in accordance with an associated syntax protocol, the generative operational program system 140 may be configured to generate an alert.

In some embodiments, the generative operational program system 140 is configured to configure an operational program. For example, the generative operational program system 140 is configured to configure an operational program after it has been generated using the generative operational program model. In this regard, in some embodiments, configuring an operational program includes the generative operational program system 140 being configured to map one or more asset feature inputs to one or more first asset feature templates. In some embodiments, a first asset feature template is a data object that is representative and/or indictive of a data stream that includes data representative of an asset feature input. In some embodiments, a data stream may be associated with (e.g., received from) the asset 102, the one or more databases 150 and/or one or more other data sources. For example, a first asset feature template may be representative of a data stream that includes an asset feature input that is representative of a current associated with a motor in the asset 102. Said differently, a first asset feature template may be a data object that indicates a particular data stream from which data representative of a particular asset input feature used by the operational program can be received from. For example, if an operational program is configured to determine an asset output feature that is representative of a voltage imbalance using an asset input feature that is representative of a motor current, a first asset feature template may be a data object that is representative of a data stream that is configured to provide the generative operational program system 140 with data representative of the motor current such that the generative operational program system 140 is able to implement the operational program.

In some embodiments, configuring an operational program includes the generative operational program system 140 being configured to map one or more asset feature outputs to one or more second asset feature templates. In some embodiments, a second asset feature template is a data object that is representative and/or indicative of an output target associated with an asset feature output determined by an operational program (e.g., an operational program implemented by the generative operational program system 140). In some embodiments, an output target is a memory location and/or data storage location in which a determined asset feature output can be stored and/or accessed from. For example, an output target may be a memory location associated with data that indicates the utilization of a pump.

In some embodiments, the generative operational program system 140 is configured to generate an operational program testing routine. In some embodiments, an operational program testing routine is a test that may be performed by the generative operational program system 140 to determine whether an operational program is functioning properly. In some embodiments, an operational program testing routine includes one or more testing asset feature inputs. In some embodiments, a testing asset feature inputs includes one or more items of data representative and/or indicative of one or more determined and/or captured features associated with the asset 102 that is used as a testing input for an operational program. For example, a testing asset feature input may be representative of a voltage associated with a motor in the asset 102 that is used as a testing input for an operational program.

Additionally, or alternatively, an operational program testing routine includes one or more testing asset feature outputs. In some embodiments, a testing asset feature output includes one or more items of data representative and/or indicative of one or more determined features associated with the asset 102 that is used for testing an output of an operational program. For example, a testing asset feature output may be representative of a voltage imbalance associated with a motor in the asset 102 that is used as a testing output for an operational program. In some embodiments, a testing asset feature output corresponds to a testing asset feature input. Said differently, for example, a testing asset feature output is representative of an output from an operational program that should be determined by an operational program from a corresponding testing asset feature input if the operational program is functioning properly.

In some embodiments, the generative operational program system 140 is configured to apply a testing routine to the operational program. In this regard, in some embodiments, applying a testing routine to an operational program include the generative operational program system 140 being configured to apply one or more testing asset feature inputs to an operational program. In some embodiments, applying a testing routine to an operational program includes the generative operational program system 140 being configured to implement an operational program with one or more testing asset feature inputs to determine one or more preliminary testing asset feature outputs. In some embodiments, applying a testing routine to an operational program includes the generative operational program system 140 being configured to compare one or more preliminary testing asset feature outputs to one or more testing asset feature outputs. In this regard, for example, the generative operational program system 140 may be configured to compare one or more preliminary testing asset feature outputs determined using an operational program and one or more testing asset feature outputs.

In some embodiments, if the generative operational program system 140 determines that one or more preliminary testing asset feature outputs match one or more testing asset feature outputs, the generative operational program system 140 is configured to determine that an operational program is functioning properly. Additionally, or alternatively, if the generative operational program system 140 determines that one or more preliminary testing asset feature outputs do not match one or more testing asset feature outputs, the generative operational program system 140 is configured to determine that an operational program is not functioning properly.

In some embodiments, if the generative operational program system 140 determines that an operational program is not functioning properly, the generative operational program system 140 is configured to generate one or more alerts indicating that the operational program is not functioning properly. Additionally, or alternatively, if the generative operational program system 140 determines that an operational program is not functioning properly, the generative operational program system 140 is configured to regenerate the operational program. In some embodiments, the generative operational program system 140 is configured to reapply the operational program testing routine to the regenerated operational program to determine if the regenerated operational program is functioning properly. Additionally, or alternatively, if the generative operational program system 140 determines that an operational program is not functioning properly, the generative operational program system 140 is configured to generate a new testing routine to determine if the regenerated operational program is functioning properly.

In some embodiments, the generative operational program system 140 is configured to initiate performance of one or more asset implementation actions. In some embodiments, the generative operational program system 140 is configured to initiate performance of one or more asset implementation actions based at least in part on an operational program, such as an operational program generated by the generative operational program system 140. In this regard, in some embodiments, initiating performance of one or more asset implementation actions includes the generative operational program system 140 being configured to generate at least one of one or more asset feature outputs. For example, the generative operational program system 140 may be configured to generate a first asset feature output of the one or more asset feature outputs. In this regard, in some embodiments, the generative operational program system 140 is configured to generate at least one of the one or more asset feature outputs by implementing an operational program using at least one of one or more asset feature inputs.

In some embodiments, initiating performance of one or more asset implementation actions includes the generative operational program system 140 being configured to detect at least one fault associated with the asset 102. In this regard, in some embodiments, the generative operational program system 140 is configured to detect at least one fault associated with the asset by determining whether one or more asset feature outputs determined using an operational program are indicative of a fault associated with the asset 102 (e.g., a value associated with an asset feature output is outside of a normal range). For example, the generative operational program system 140 may be configured to detect a fault associated with the asset 102 by determining that a voltage imbalance associated with a motor in the asset 102 is indicative of a fault associated with the asset 102 (e.g., the motor is close to failing or has already failed).

In some embodiments, initiating performance of one or more asset implementation actions includes the generative operational program system 140 being configured to transmit at least one operational action instruction to a remote computing device. For example, the generative operational program system 140 may be configured to transmit at least one operational action instruction to a remote computing device that is associated with the asset 102 (e.g., a remote computing device that is located at the asset 102 when the generative operational program system 140 and the asset 102 are located remotely from each other).

In some embodiments, an operational action instruction includes one or more items of data that are representative and/or indicative of instructions for adjusting operations of the asset 102. In this regard, for example, the generative operational program system 140 may be configured to transmit an operational action instruction to a remote computing device when the generative operational program system 140 has determined that the asset 102 is affected by a fault (e.g., so that the fault can be remedied).

In some embodiments, initiating performance of one or more asset implementation actions includes the generative operational program system 140 being configured to cause actuation of one or more components of the asset 102. For example, the generative operational program system 140 may be configured to cause actuation of a pump component of the asset 102 (e.g., cause the pump to shut down or start up), an interface component of the asset 102, a motor component of the asset 102, and/or the like. In some embodiments, the generative operational program system 140 is configured to cause actuation of one or more components of the asset 102 in response to detecting a fault associated with the asset 102 (e.g., by detecting a fault using an operational program). Additionally, or alternatively, the generative operational program system 140 is configured to cause actuation of one or more components of the asset 102 in response to determining one or more ways to improve efficiency of the asset 102 (e.g., by determining one or more ways to improve efficiency using an operational program).

In some embodiments, initiating performance of one or more asset implementation actions includes the generative operational program system 140 being configured to generate one or more operational program implementation interface components. For example, initiating performance of one or more asset implementation actions includes the generative operational program system 140 being configured to generate one or more operational program implementation interface components based on an operational program (e.g., using one or more asset feature outputs generated using an operational program).

In some embodiments, the one or more operational program implementation interface components include an operational program generation interface component 402. In some embodiments, the operational program generation interface component 402 includes one or more first operational program interface elements 404. In some embodiments, the one or more first operational program interface elements 404 are configured to display a visual representation of the first portion of an operational program. In this regard, in some embodiments, the one or more first operational program interface elements 404 are configured to display a visual representation of one or more computing programs, computing formulas, and/or computing operations that that represent a relationship between one or more asset feature inputs and one or more asset feature outputs (e.g., a visual representation of a machine-readable language). Additionally, or alternatively, the operational program generation interface component 402 includes one or more second operational program interface elements 406. In this regard, in some embodiments, the one or more second operational program interface elements 406 are configured to display the second portion of an operational program. In this regard, in some embodiments, the one or more second operational program interface elements 406 are configured to display one or more configuration instructions.

In some embodiments, the generative operational program system 140 is configured to cause the operational program generation interface component 402 to be rendered to the operational program interface 300. In this regard, in some embodiments, the operational program generation interface component 402 may be accessed using the generative operational program system 140, the user device 160, a computing device associated with the asset 102, and/or one or more external systems (e.g., a remote computing device).

In some embodiments, the one or more operational program implementation interface components include an operational program configuration interface component 408. In some embodiments, the operational program configuration interface component 408 includes a first asset feature template interface element 410. In some embodiments, the first asset feature template interface element 410 is configured to display a mapping between one or more asset feature inputs and one or more first asset feature templates. In some embodiments, the operational program configuration interface component 408 includes a second asset feature template interface element 412. In some embodiments, the second asset feature template interface element 412 is configured to display a mapping between one or more asset feature outputs and one or more second asset feature templates.

In some embodiments, the generative operational program system 140 is configured to cause the operational program configuration interface component 408 to be rendered to the operational program interface 300. In this regard, in some embodiments, the operational program configuration interface component 408 may be accessed using the generative operational program system 140, the user device 160, a computing device associated with the asset 102, and/or one or more external systems (e.g., a remote computing device). In some embodiments, the operational program configuration interface component 408 is rendered next to the operational program generation interface component 402 on the operational program interface 300.

In some embodiments, the one or more operational program implementation interface components include an operational program testing routine interface component 502. In some embodiments, the operational program testing routine interface component 502 includes a testing input interface element 504. In some embodiments, the testing input interface element 504 is configured to display one or more testing asset feature inputs. In some embodiments, the operational program testing routine interface component 502 includes a testing output interface element 506. In some embodiments, the testing output interface element 506 is configured to display one or more testing asset feature outputs.

In some embodiments, the operational program testing routine interface component 502 includes a testing routine outcome interface element 508. In some embodiments, the testing routine outcome interface element 508 is configured to display a result of an operational program testing routine. For example, the testing routine outcome interface element 508 may be configured to display whether an operational program is functioning properly. In some embodiments, the operational program testing routine interface component 502 includes a testing routine trigger interface element 510. In some embodiments, the testing routine trigger interface element 510 is configured to be selected to trigger an operational program testing routine.

In some embodiments, the generative operational program system 140 is configured to cause the operational program testing routine interface component 502 to be rendered to the operational program interface 300. In this regard, in some embodiments, the operational program testing routine interface component 502 may be accessed using the generative operational program system 140, the user device 160, a computing device associated with the asset 102, and/or one or more external systems (e.g., a remote computing device).

In some embodiments, the one or more operational program implementation interface components includes an operational program output interface component 602. In some embodiments, the operational program output interface component 602 is configured to display one or more asset feature outputs, such as a first asset feature output. Additionally, or alternatively, the operational program output interface component 602 is configured to display one or more faults associated with the asset 102 that were detected using an operational program. Additionally, or alternatively, the operational program output interface component 602 is configured to display information that identifies the asset 102 and/or an implementation domain associated with the asset 102.

In some embodiments, the generative operational program system 140 is configured to cause the operational program output interface component 602 to be rendered to the operational program interface 300. In this regard, in some embodiments, the operational program output interface component 602 may be accessed using the generative operational program system 140, the user device 160, a computing device associated with the asset 102, and/or one or more external systems (e.g., a remote computing device).

### Example Methods

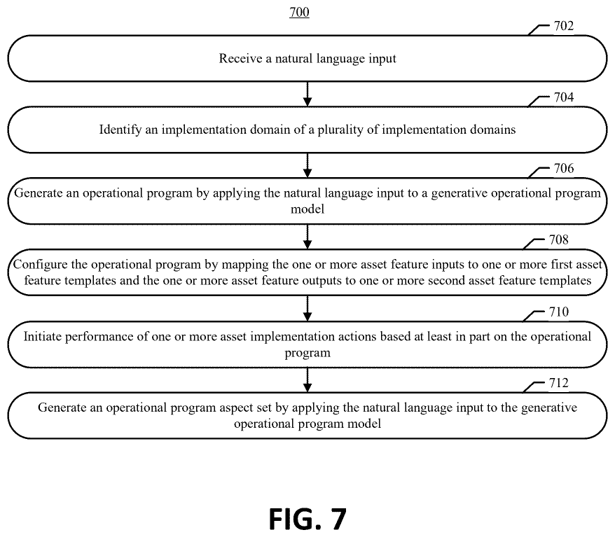

Referring now to FIG. 7, a flowchart providing an example method 700 is illustrated. In this regard, FIG. 7 illustrates operations that may be performed by the generative operational program system 140, the user device 160, the asset 102, and/or the like. In some embodiments, the method 700 includes operations for generating and/or configurating an operational program. In some embodiments, the example method 700 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 700.

As shown in block 702, the method 700 may include receiving a natural language input. As described above, in some embodiments, a natural language input includes words, phrases, sentences paragraphs, messages, prompts, and/or the like. In some embodiments, a natural language input includes words, phrases, sentences, paragraphs, messages, prompts, and/or the like that represent instructions for generating an operational program. For example, a natural language input may include words, phrases, sentences, paragraphs, messages, prompts, and/or the like that represent instructions for generating an operational program associated with a voltage imbalance of an electric motor, such as an electric motor associated with the asset 102. As another example, a natural language input may include words, phrases, sentences, paragraphs, messages, prompts, and/or the like that represent instructions for determining a pump utilization, such as a pump associated with the asset 102.

In some embodiments, the generative operational program system 140 is configured to receive a natural language input via a natural language input interface component 302. In this regard, in some embodiments, the generative operational program system 140 is configured to generate the natural language input interface component 302. In some embodiments, the natural language input interface component 302 includes a natural language interface element 304. In some embodiments, the natural language interface element 304 is configured to be used by a user to input a natural language input via the natural language interface element 304. In some embodiments, the natural language input interface component 302 includes an operational program generation interface element 306.

In some embodiments, the generative operational program system 140 is configured to cause the natural language input interface component 302 to be rendered to an operational program interface 300. In some embodiments, the operational program interface 300 is configured to be provided on the generative operational program system 140, the user device 160, a computing device associated with the asset 102, and/or one or more external systems (e.g., a remote computing device).

As shown in block 704, the method 700 may include identifying an implementation domain of a plurality of implementation domains. As described above, in some embodiments, the generative operational program system 140 is configured to identify an implementation domain associated with the natural language input. In this regard, in some embodiments, the generative operational program system 140 is configured to identify the implementation domain of the plurality of implementation domains associated with the natural language input. For example, if the natural language input is associated with an industrial implementation domain, the generative operational program system 140 may be configured to identify the industrial implementation domain.

In some embodiments, identifying an implementation domain of the plurality of implementation domains includes the generative operational program system 140 being configured to receive an indication of an implementation domain. For example, the generative operational program system 140 may receive an indication of a particular implementation domain of the plurality of implementation domains via the natural language input interface component 302. Said differently, for example, the natural language input interface component 302 may be configured such that a user can input a natural language input and/or indicate an implementation domain using the natural language input interface component 302.

Additionally, or alternatively, identifying an implementation domain of the plurality of implementation domains includes the generative operational program system 140 being configured to determine the implementation using a natural language input. In this regard, in some embodiments, the generative operational program system 140 is configured to use the words, phrases, sentences, paragraphs, messages, prompts, and/or the like provided in a natural language input to determine an implementation domain (e.g., an implementation domain associated with the natural language input). For example, if a natural language input includes the word pump, the generative operational program system 140 may be configured to determine that the natural language input is associated with an industrial implementation domain of the plurality of implementation domains. As another example, if a natural language input includes a sentence that describes aircraft operations, the generative operational program system 140 may be configured to determine that the natural language input is associated with an aerospace implementation domain of the plurality of implementation domains.

In some embodiments, each of the plurality of implementation domains is associated with one or more of a plurality of domain languages. In some embodiments, a domain language is a programming language that is used to carry out computing operations in a particular implementation domain. For example, a domain language may include a python-based language, a domain specific language, and/or the like. In some embodiments, a domain language is in a machine-readable format (e.g., a format readable by machines and/or computing devices). In some embodiments, a domain language in a machine-readable format is not readable or understandable by a user (e.g., a human) associated with the generative operational program system 140.

As shown in block 706, the method 700 may include generating an operational program by applying the natural language input to a generative operational program model. As described above, in some embodiments, an asset feature input includes one or more items of data representative and/or indicative of one or more determined and/or captured features associated with the asset 102 that is an input to an operational program. For example, an asset feature input may be representative of a voltage associated with a motor in the asset 102. As another example, an asset feature input may be representative of a current associated with a motor in the asset 102. As another example, an asset feature input may be representative of a density associated with a component of the asset 102. As another example, an asset feature input may be representative of a design efficiency associated with a component of the asset 102. As another example, an asset feature input may be representative of an electrical power associated with the asset 102. As another example, an asset feature input may be representative of a flow rate associated with a pump in the asset 102. In some embodiments, identifying one or more asset feature inputs includes the generative operational program system 140 being configured to receive the one or more asset feature inputs, such as from the asset 102. Additionally, or alternatively, identifying one or more asset feature inputs includes the generative operational program system 140 being configured to determine one or more asset feature inputs. For example, the generative operational program system 140 may be configured to determine one or more asset feature inputs using one or more previously received asset feature inputs.

In some embodiments, an asset feature output includes one or more items of data representative and/or indicative of one or more determined features associated with the asset 102 that is an output of an operational program. For example, an asset feature output may be representative of a voltage imbalance associated with a motor in the asset 102. As another example, an asset feature output may be representative of a utilization associated with a pump in the asset 102. As another example, an asset feature output may be representative of a breakeven point associated with the asset 102. As another example, an asset feature output may be representative of a degradation loss associated with a component in the asset 102.

In some embodiments, an operational program includes a first portion. In some embodiments, the first portion of an operational program includes one or more computing programs, computing formulas, and/or computing operations that that represent a relationship between one or more asset feature inputs and one or more asset feature outputs. In this regard, in some embodiments, the first portion of an operational program may include computing programs, computing formulas, and/or computing operations that are implemented to determine one or more feature outputs using one or more feature inputs. For example, the first portion of an operational program may include computing programs, computing formulas, and/or computing operations that are implemented to determine a voltage imbalance (e.g., an asset feature output) using a motor current (e.g., an asset feature input).

In some embodiments, the first portion of an operational program is structured in accordance with a domain language of the plurality of languages. In this regard, in some embodiments, the first portion of an operational program is structured in a machine-readable format. In some embodiments, the first portion of an operational program is structured in accordance with a domain language that corresponds to an implementation domain associated with the asset 102 and/or an implementation domain identified by the generative operational program system 140. For example, the first portion of an operational program may be structured in accordance with a python-based language when an implementation domain associated with the asset 102 uses the python-based language.

In some embodiments, an operational program includes a second portion. In some embodiments, the second portion of an operational program includes one or more configuration instructions. In some embodiments, a configuration instruction includes one or more items of data representative and/or indicative of an instruction or explanation related to one or more computing programs, computing formulas, and/or computing operations included in the first portion of an operational program. For example, a configuration instruction may include an instruction and/or explanation related to a particular computing operation included in the first portion of an operational program (e.g., that the purpose of a particular computing operation is to determine a current associated with a motor).

In some embodiments, the second portion of an operational program is structured in accordance with a natural language format. In this regard, in some embodiments, the second portion of an operational program includes one or more configuration instructions that are provided in words, phrases, sentences paragraphs, messages, prompts, and/or the like.

In some embodiments, the generative operational program system 140 is configured to generate an operational program and/or an operational program aspect set by applying a natural language input to a generative operational program model. In some embodiments, the generative operational program model is a data entity that describes parameters, hyper-parameters, and/or defined operations of a rules-based, machine learning model, and/or generative artificial intelligence model (e.g., model including at least one of one or more rule-based layers, one or more layers that depend on trained parameters, coefficients, and/or the like) configured to generate an operational program and/or an operational program aspect set. In this regard, in some embodiments, the generative operational program model may be configured to utilize one or more of any type of machine learning, rules-based, and/or artificial intelligence techniques including one or more of computer vision techniques, supervised learning (e.g., using user feedback), unsupervised learning, semi-supervised learning, reinforcement learning, computer vision techniques, sequence modeling techniques, language processing techniques, neural network techniques, generative artificial intelligence techniques, filtration techniques, grouping techniques, sorting techniques, trend techniques, correlation techniques, anomaly detection techniques, clustering techniques, and/or the like.

In some embodiments, the generative operational program system 140 is configured to generate an operational program in response to receiving a natural language input. For example, the generative operational program system 140 may be configured to generate an operational program upon receiving a natural language input. Additionally, or alternatively, the generative operational program system 140 is configured to generate an operational program in response to a selection of the operational program generation interface element 306.

As shown in block 708, the method 700 may include configuring the operational program by mapping the one or more asset feature inputs to one or more first asset feature templates and the one or more asset feature outputs to one or more second asset feature templates. As described above, in some embodiments, the generative operational program system 140 is configured to configure an operational program after it has been generated using the generative operational program model. In this regard, in some embodiments, configuring an operational program includes the generative operational program system 140 being configured to map one or more asset feature inputs to one or more first asset feature templates. In some embodiments, a first asset feature template is a data object that is representative and/or indictive of a data stream that includes data representative of an asset feature input. In some embodiments, a data stream may be associated with (e.g., received from) the asset 102, the one or more databases 150 and/or one or more other data sources. For example, a first asset feature template may be representative of a data stream that includes an asset feature input that is representative of a current associated with a motor in the asset 102. Said differently, a first asset feature template may be a data object that indicates a particular data stream from which data representative of a particular asset input feature used by the operational program can be received from. For example, if an operational program is configured to determine an asset output feature that is representative of a voltage imbalance using an asset input feature that is representative of a motor current, a first asset feature template may be a data object that is representative of a data stream that is configured to provide the generative operational program system 140 with data representative of the motor current such that the generative operational program system 140 is able to implement the operational program.

In some embodiments, configuring an operational program includes the generative operational program system 140 being configured to map one or more asset feature outputs to one or more second asset feature templates. In some embodiments, a second asset feature template is a data object that is representative and/or indicative of an output target associated with an asset feature output determined by an operational program (e.g., an operational program implemented by the generative operational program system 140). In some embodiments, an output target is a memory location and/or data storage location in which a determined asset feature output can be stored and/or accessed from. For example, an output target may be a memory location associated with data that indicates the utilization of a pump.

As shown in block 710, the method 700 may include initiating performance of one or more asset implementation actions based at least in part on the operational program. As described above, in some embodiments, the operational program used to initiate performance of one or more asset implementation actions is generated by the generative operational program system 140

As shown in block 712, the method 700 may include generating an operational program aspect set by applying the natural language input to the generative operational program model. As described above, in some embodiments, the generative operational program system 140 may be configured to generate an operational program aspect set that is associated with a generated operational program. In some embodiments, an operational program aspect set is structured in accordance with a natural language format. Additionally, or alternatively, an operational program aspect set is structured in accordance with a machine-readable format, such as in a particular domain language.

In some embodiments, an operational program aspect set includes a program type associated with an operational program. In this regard, in some embodiments, a program type is representative of types of asset feature outputs that are determined using an operational program. For example, a program type may be representative of a voltage imbalance when an operational program is configured to determine one or more asset feature outputs that include a voltage imbalance.

In some embodiments, an operational program aspect set includes a program name associated with an operational program. In this regard, in some embodiments, a program name is representative of a name associated with an operational program. In some embodiments, a program name may be generated in accordance with a naming convention associated with the asset 102, an implementation domain associated with the asset 102, and/or a domain language associated with an implementation domain.

In some embodiments, an operational program aspect set includes a program description associated with an operational program. In some embodiments, a program description is representative of a description of one or more computing programs, computing formulas, and/or computing operations that are included in an operational program.

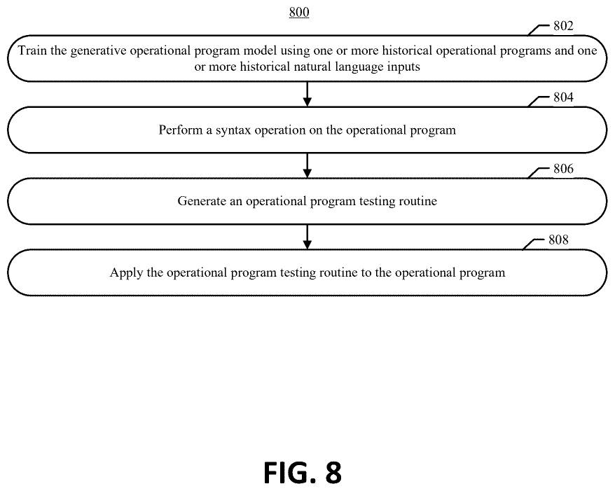

Referring now to FIG. 8, a flowchart providing an example method 800 is illustrated. In this regard, FIG. 8 illustrates operations that may be performed by the generative operational program system 140, the user device 160, the asset 102, and/or the like. In some embodiments, the method 800 includes operations for optimizing one or more operational programs and/or one or more generative operational program models. In some embodiments, the example method 800 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 800.

As shown in block 802, the method 800 may include training the generative operational program model using one or more historical operational programs and one or more historical natural language inputs. As described above, in some embodiments, training the generative operational model includes the generative operational program system 140 being configured cause the generative operational program model to generate a training operational program using the one or more historical natural language inputs and then compare the training operational program against the one or more historical operational programs.

As shown in block 804, the method 800 may include performing a syntax operation on the operational program. As described above, in some embodiments, the generative operational program system 140 may be configured to perform a syntax operation on the operational program after the operational program has been generated by the generative operational program system 140 using the generative operational program model. In some embodiments, a syntax operation includes a computing operation configured to determine whether the syntax of the first portion of an operational program was generated in accordance with a syntax protocol associated the domain language in which the first portion of the operational program is structured in accordance with. In some embodiments, if a syntax operation determines that the first portion of an operational program is not in accordance with an associated syntax protocol, the generative operational program system 140 may be configured to generate an alert. Additionally, or alternatively, a syntax operation includes a computing operation configured to determine whether the syntax of the second portion of an operational program was generated in accordance with a syntax protocol of a natural language format. In some embodiments, if a syntax operation determines that the second portion of an operational program is not in accordance with an associated syntax protocol, the generative operational program system 140 may be configured to generate an alert.

As shown in block 806, the method 800 may include generating an operational program testing routine. As described above, in some embodiments, an operational program testing routine is a test that may be performed by the generative operational program system 140 to determine whether an operational program is functioning properly. In some embodiments, an operational program testing routine includes one or more testing asset feature inputs. In some embodiments, a testing asset feature inputs includes one or more items of data representative and/or indicative of one or more determined and/or captured features associated with the asset 102 that is used as a testing input for an operational program. For example, a testing asset feature input may be representative of a voltage associated with a motor in the asset 102 that is used as a testing input for an operational program.

Additionally, or alternatively, an operational program testing routine includes one or more testing asset feature outputs. In some embodiments, a testing asset feature output includes one or more items of data representative and/or indicative of one or more determined features associated with the asset 102 that is used for testing an output of an operational program. For example, a testing asset feature output may be representative of a voltage imbalance associated with a motor in the asset 102 that is used as a testing output for an operational program. In some embodiments, a testing asset feature output corresponds to a testing asset feature input. Said differently, for example, a testing asset feature output is representative of an output from an operational program that should be determined by an operational program from a corresponding testing asset feature input if the operational program is functioning properly.

As shown in block 808, the method 800 may include applying the operational program testing routine to the operational program. As described above, in some embodiments, applying a testing routine to an operational program include the generative operational program system 140 being configured to apply one or more testing asset feature inputs to an operational program. In some embodiments, applying a testing routine to an operational program includes the generative operational program system 140 being configured to implement an operational program with one or more testing asset feature inputs to determine one or more preliminary testing asset feature outputs. In some embodiments, applying a testing routine to an operational program includes the generative operational program system 140 being configured to compare one or more preliminary testing asset feature outputs to one or more testing asset feature outputs. In this regard, for example, the generative operational program system 140 may be configured to compare one or more preliminary testing asset feature outputs determined using an operational program and one or more testing asset feature outputs.

In some embodiments, if the generative operational program system 140 determines that one or more preliminary testing asset feature outputs match one or more testing asset feature outputs, the generative operational program system 140 is configured to determine that an operational program is functioning properly. Additionally, or alternatively, if the generative operational program system 140 determines that one or more preliminary testing asset feature outputs do not match one or more testing asset feature outputs, the generative operational program system 140 is configured to determine that an operational program is not functioning properly.

In some embodiments, if the generative operational program system 140 determines that an operational program is not functioning properly, the generative operational program system 140 is configured to generate one or more alerts indicating that the operational program is not functioning properly. Additionally, or alternatively, if the generative operational program system 140 determines that an operational program is not functioning properly, the generative operational program system 140 is configured to regenerate the operational program. In some embodiments, the generative operational program system 140 is configured to reapply the operational program testing routine to the regenerated operational program to determine if the regenerated operational program is functioning properly. Additionally, or alternatively, if the generative operational program system 140 determines that an operational program is not functioning properly, the generative operational program system 140 is configured to generate a new testing routine to determine if the regenerated operational program is functioning properly.

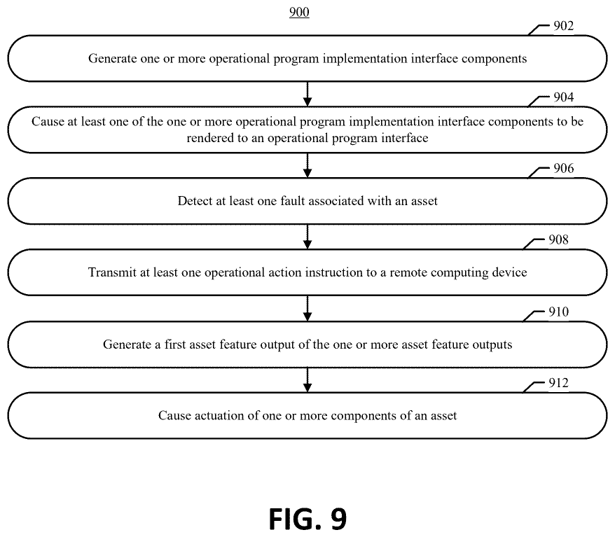

Referring now to FIG. 9, a flowchart providing an example method 900 is illustrated. In this regard, FIG. 9 illustrates operations that may be performed by the generative operational program system 140, the user device 160, the asset 102, and/or the like. In some embodiments, the method 900 includes operations for initiating performance of one or more asset implementation actions. In some embodiments, the example method 900 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 900.

As shown in block 902, the method 900 may include generating one or more operational program implementation interface components. As described above, in some embodiments, the one or more operational program implementation interface components include an operational program generation interface component 402. In some embodiments, the operational program generation interface component 402 includes one or more first operational program interface elements 404. In some embodiments, the one or more first operational program interface elements 404 are configured to display a visual representation of the first portion of an operational program. In this regard, in some embodiments, the one or more first operational program interface elements 404 are configured to display a visual representation of one or more computing programs, computing formulas, and/or computing operations that that represent a relationship between one or more asset feature inputs and one or more asset feature outputs (e.g., a visual representation of a machine-readable language). Additionally, or alternatively, the operational program generation interface component 402 includes one or more second operational program interface elements 406. In this regard, in some embodiments, the one or more second operational program interface elements 406 are configured to display the second portion of an operational program. In this regard, in some embodiments, the one or more second operational program interface elements 406 are configured to display one or more configuration instructions.

In some embodiments, the one or more operational program implementation interface components include an operational program configuration interface component 408. In some embodiments, the operational program configuration interface component 408 includes a first asset feature template interface element 410. In some embodiments, the first asset feature template interface element 410 is configured to display a mapping between one or more asset feature inputs and one or more first asset feature templates. In some embodiments, the operational program configuration interface component 408 includes a second asset feature template interface element 412. In some embodiments, the second asset feature template interface element 412 is configured to display a mapping between one or more asset feature outputs and one or more second asset feature templates.

In some embodiments, the one or more operational program implementation interface components include an operational program testing routine interface component 502. In some embodiments, the operational program testing routine interface component 502 includes a testing input interface element 504. In some embodiments, the testing input interface element 504 is configured to display one or more testing asset feature inputs. In some embodiments, the operational program testing routine interface component 502 includes a testing output interface element 506. In some embodiments, the testing output interface element 506 is configured to display one or more testing asset feature outputs.

In some embodiments, the operational program testing routine interface component 502 includes a testing routine outcome interface element 508. In some embodiments, the testing routine outcome interface element 508 is configured to display a result of an operational program testing routine. For example, the testing routine outcome interface element 508 may be configured to display whether an operational program is functioning properly. In some embodiments, the operational program testing routine interface component 502 includes a testing routine trigger interface element 510. In some embodiments, the testing routine trigger interface element 510 is configured to be selected to trigger an operational program testing routine.

In some embodiments, the one or more operational program implementation interface components includes an operational program output interface component 602. In some embodiments, the operational program output interface component 602 is configured to display one or more asset feature outputs, such as a first asset feature output. Additionally, or alternatively, the operational program output interface component 602 is configured to display one or more faults associated with the asset 102 that were detected using an operational program. Additionally, or alternatively, the operational program output interface component 602 is configured to display information that identifies the asset 102 and/or an implementation domain associated with the asset 102.

As shown in block 904, the method 900 may include causing at least one of the one or more operational program implementation interface components to be rendered to an operational program interface. As described above, in some embodiments, the generative operational program system 140 is configured to cause the operational program generation interface component 402 to be rendered to the operational program interface 300. In this regard, in some embodiments, the operational program generation interface component 402 may be accessed using the generative operational program system 140, the user device 160, a computing device associated with the asset 102, and/or one or more external systems (e.g., a remote computing device).

In some embodiments, the generative operational program system 140 is configured to cause the operational program configuration interface component 408 to be rendered to the operational program interface 300. In this regard, in some embodiments, the operational program configuration interface component 408 may be accessed using the generative operational program system 140, the user device 160, a computing device associated with the asset 102, and/or one or more external systems (e.g., a remote computing device). In some embodiments, the operational program configuration interface component 408 is rendered next to the operational program generation interface component 402 on the operational program interface 300.

In some embodiments, the generative operational program system 140 is configured to cause the operational program testing routine interface component 502 to be rendered to the operational program interface 300. In this regard, in some embodiments, the operational program testing routine interface component 502 may be accessed using the generative operational program system 140, the user device 160, a computing device associated with the asset 102, and/or one or more external systems (e.g., a remote computing device).

In some embodiments, the generative operational program system 140 is configured to cause the operational program output interface component 602 to be rendered to the operational program interface 300. In this regard, in some embodiments, the operational program output interface component 602 may be accessed using the generative operational program system 140, the user device 160, a computing device associated with the asset 102, and/or one or more external systems (e.g., a remote computing device).

As shown in block 906, the method 900 may include detecting at least one fault associated with an asset. As described above, in some embodiments, generative operational program system 140 is configured to detect at least one fault associated with the asset by determining whether one or more asset feature outputs determined using an operational program are indicative of a fault associated with the asset 102 (e.g., a value associated with an asset feature output is outside of a normal range). For example, the generative operational program system 140 may be configured to detect a fault associated with the asset 102 by determining that a voltage imbalance associated with a motor in the asset 102 is indicative of a fault associated with the asset 102 (e.g., the motor is close to failing or has already failed).

As shown in block 908, the method 900 may include transmitting at least one operational action instruction to a remote computing device. As described above, in some embodiments, the generative operational program system 140 may be configured to transmit at least one operational action instruction to a remote computing device that is associated with the asset 102 (e.g., a remote computing device that is located at the asset 102 when the generative operational program system 140 and the asset 102 are located remotely from each other).

In some embodiments, an operational action instruction includes one or more items of data that are representative and/or indicative of instructions for adjusting operations of the asset 102. In this regard, for example, the generative operational program system 140 may be configured to transmit an operational action instruction to a remote computing device when the generative operational program system 140 has determined that the asset 102 is affected by a fault (e.g., so that the fault can be remedied).

As shown in block 910, the method 900 may include generating a first asset feature output of the one or more asset feature outputs. As described above, in some embodiments, the generative operational program system 140 may be configured to generate a first asset feature output of the one or more asset feature outputs. In this regard, in some embodiments, the generative operational program system 140 is configured to generate at least one of the one or more asset feature outputs by implementing an operational program using at least one of one or more asset feature inputs.

As shown in block 912, the method 900 may include causing actuation of one or more components of an asset. As described above, in some embodiments, the generative operational program system 140 may be configured to cause actuation of a pump component of the asset 102 (e.g., cause the pump to shut down or start up), an interface component of the asset 102, a motor component of the asset 102, and/or the like. In some embodiments, the generative operational program system 140 is configured to cause actuation of one or more components of the asset 102 in response to detecting a fault associated with the asset 102 (e.g., by detecting a fault using an operational program). Additionally, or alternatively, the generative operational program system 140 is configured to cause actuation of one or more components of the asset 102 in response to determining one or more ways to improve efficiency of the asset 102 (e.g., by determining one or more ways to improve efficiency using an operational program).

Operations and/or functions of the present disclosure have been described herein, such as in flowcharts. As will be appreciated, computer program instructions may be loaded onto a computer or other programmable apparatus (e.g., hardware) to produce a machine, such that the resulting computer or other programmable apparatus implements the operations and/or functions described in the flowchart blocks herein. These computer program instructions may also be stored in a computer-readable memory that may direct a computer, processor, or other programmable apparatus to operate and/or function in a particular manner, such that the instructions stored in the computer-readable memory produce an article of manufacture, the execution of which implements the operations and/or functions described in the flowchart blocks. The computer program instructions may also be loaded onto a computer, processor, or other programmable apparatus to cause a series of operations to be performed on the computer, processor, or other programmable apparatus to produce a computer-implemented process such that the instructions executed on the computer, processor, or other programmable apparatus provide operations for implementing the functions and/or operations specified in the flowchart blocks. The flowchart blocks support combinations of means for performing the specified operations and/or functions and combinations of operations and/or functions for performing the specified operations and/or functions. It will be understood that one or more blocks of the flowcharts, and combinations of blocks in the flowcharts, can be implemented by special purpose hardware-based computer systems which perform the specified operations and/or functions, or combinations of special purpose hardware with computer instructions.

While this specification contains many specific embodiments and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

Similarly, while operations are illustrated in the drawings in a particular order, this should not be understood as requiring that such operations be performed in the particular order shown or in sequential order, or that all illustrated operations be performed, to achieve desirable results. In certain circumstances, operations in alternative ordering may be advantageous. In some cases, the actions recited in the claims may be performed in a different order and still achieve desirable results.

1. A method comprising:
receiving a natural language input;
identifying an implementation domain of a plurality of implementation domains, wherein the implementation domain is associated with the natural language input, wherein the implementation domain is associated with a domain language of a plurality of domain languages;
generating an operational program by applying the natural language input to a generative operational program model, wherein a first portion of the operational program is structured in accordance with the domain language, wherein the operational program is configured to determine one or more asset feature outputs using one or more asset feature inputs;
configuring the operational program by mapping the one or more asset feature inputs to one or more first asset feature templates and the one or more asset feature outputs to one or more second asset feature templates; and
initiating performance of one or more asset implementation actions based at least in part on the operational program.

2. The method of claim 1, wherein the implementation domain is one of an aerospace implementation domain, a structures implementation domain, an industrial implementation domain, a science implementation domain, a cybersecurity implementation domain, or an operations implementation domain.

3. The method of claim 1, wherein the implementation domain corresponds to an asset.

4. The method of claim 1, further comprising:
training the generative operational program model using one or more historical operational programs and one or more historical natural language inputs.

5. The method of claim 1, further comprising:
generating an operational program aspect set by applying the natural language input to the generative operational program model.

6. The method of claim 1, wherein a second portion of the operational program is structured in accordance with a natural language format.

7. The method of claim 1, further comprising:
performing a syntax operation on the operational program.

8. The method of claim 1, further comprising:
generating an operational program testing routine, wherein the operational program testing routine comprises one or more testing asset feature inputs and one or more testing asset feature outputs; and
applying the operational program testing routine to the operational program.

9. The method of claim 1, wherein initiating performance of the one or more asset implementation actions:
generating one or more operational program implementation interface components; and
causing at least one of the one or more operational program implementation interface components to be rendered to an operational program interface.

10. The method of claim 9, wherein the one or more operational program implementation interface components comprise one or more of an operational program generation interface component, an operational program configuration interface component, an operational program testing routine interface component, or an operational program output interface component.

11. The method of claim 1, wherein initiating performance of the one or more asset implementation actions:
detecting at least one fault associated with an asset.

12. The method of claim 1, wherein initiating performance of the one or more asset implementation actions:
transmitting at least one operational action instruction to a remote computing device.

13. The method of claim 1, wherein initiating performance of the one or more asset implementation actions:
generating a first asset feature output of the one or more asset feature outputs.

14. The method of claim 1, wherein initiating performance of the one or more asset implementation actions:
causing actuation of one or more components of an asset.

15. An apparatus comprising memory and one or more processors communicatively coupled to the memory, the one or more processors configured to:
receive a natural language input;
identify an implementation domain of a plurality of implementation domains, wherein the implementation domain is associated with the natural language input, wherein the implementation domain is associated with a domain language of a plurality of domain languages;
generate an operational program by applying the natural language input to a generative operational program model, wherein a first portion of the operational program is structured in accordance with the domain language, wherein the operational program is configured to determine one or more asset feature outputs using one or more asset feature inputs;
configure the operational program by mapping the one or more asset feature inputs to one or more first asset feature templates and the one or more asset feature outputs to one or more second asset feature templates; and
initiate performance of one or more asset implementation actions based at least in part on the operational program.

16. The apparatus of claim 15, wherein the implementation domain is one of an aerospace implementation domain, a structures implementation domain, an industrial implementation domain, a science implementation domain, a cybersecurity implementation domain, or an operations implementation domain.

17. The apparatus of claim 15, wherein a second portion of the operational program is structured in accordance with a natural language format.

18. The apparatus of claim 15, further comprising:
performing a syntax operation on the operational program.

19. The apparatus of claim 15, further comprising:
generating an operational program testing routine, wherein the operational program testing routine comprises one or more testing asset feature inputs and one or more testing asset feature outputs; and
applying the operational program testing routine to the operational program.

20. A computer program product comprising at least one non-transitory computer-readable storage medium having computer program code stored thereon that, in execution with at least one processor, configures the computer program product for:
receiving a natural language input;
identifying an implementation domain of a plurality of implementation domains, wherein the implementation domain is associated with the natural language input, wherein the implementation domain is associated with a domain language of a plurality of domain languages;
generating an operational program by applying the natural language input to a generative operational program model, wherein a first portion of the operational program is structured in accordance with the domain language, wherein the operational program is configured to determine one or more asset feature outputs using one or more asset feature inputs;
configuring the operational program by mapping the one or more asset feature inputs to one or more first asset feature templates and the one or more asset feature outputs to one or more second asset feature templates; and
initiating performance of one or more asset implementation actions based at least in part on the operational program.
